(19) United States
(12) Patent Application Publication
(10) Pub. No.: US 2026/0228216 A1
(43) Pub. Date: Aug. 6, 2026

(54) INTELLIGENT QUERY PERFORMANCE ANALYSIS SYSTEM FOR FLEET OF MULTI-TENANT DATABASE SERVERS

(71) Applicant: Salesforce, Inc., San Francisco, CA (US)

(72) Inventors: Kumar Aurindam, Hyderabad (IN); Vimalraj Subash, Hyderabad (IN); Ananth Sriram Chitturu, Hyderabad (IN); Rajesh Narra, Dallas, TX (US)

(73) Assignee: Salesforce, Inc., San Francisco, CA (US)

(21) Appl. No.: 19/084,749

(22) Filed: Mar. 19, 2025

(30) Foreign Application Priority Data
Jan. 31, 2025 (IN) 202541008428

(51) Int. Cl. G06F 16/2452; G06F 40/284

(52) U.S. Cl. CPC G06F 16/24528; G06F 40/284

(57) ABSTRACT

One method of identifying resource intensive queries involves receiving queries from at least one database server into an ingestion pipeline within a computing device, wherein keywords are extracted from the queries at multiple intervals; applying tokenization in the ingestion pipeline to remove uninformative terms; detecting at least one query from the received set of queries that are resource intensive at a fleet level, individual server level, or user level based on the keywords and using an enrichment analysis module, wherein the at least one query detected to be resource intensive is given a drill-down analysis to capture insights from execution profiles; and providing alerts based on the at least one query detected to be resource intensive.

### TECHNICAL FIELD

One or more implementations relate to identifying expensive and resource intensive queries received from a plurality of databases, and identifying which of the expensive and resource intensive queries include a critical threat.

### BACKGROUND

Large scale platforms can face several issues. For instance, the large scale platforms that have a fleet of multi-tenant database servers can have a substantial number of queries with sub-optimal plans. Some of these expensive queries, if executed across multiple or all database servers could cause fleet wide resource consumption regression and also pose higher threat to platform availability. A need can exist to capture and monitor individual query's fleet level impact and subsequent detecting, categorizing, and flagging of problematic queries.

It is also important to find customer implementations. With the customer implementations, in house platforms and third party packages can be expensive in nature. Detecting, flagging, and optimizing these implementations can significantly reduce database layer regressions.

Another issue is that some platforms hash a query text to assign unique identification to a database query. The unique identification helps the platform to keep track of queries and also their stats and performances. Many query tuning operations can lead to change in the underlying query text and the corresponding query identification. With this change, it can be difficult to keep track of query and its corresponding stat and performance. As such, measuring and mapping resource gains post tuning can become difficult.

A need exits for a system to identify the resource intensive queries. Further, a need exits for a system to categorize the resource intensive queries and flag the resource intensive queries that are critical to enable the system to eliminate the critical queries that affect the system's functionality and viability.

### BRIEF DESCRIPTION OF THE DRAWINGS

The following figures use like reference numbers to refer to like elements. Although the following figures depict various example implementations, alternative implementations are within the spirit and scope of the appended claims. In the drawings:

FIG. 1 depicts a flow diagram and a block diagram of a system intaking queries from multiple databases according to some exemplary implementations;

FIG. 2 is a flow and block diagram illustrating a detailed view of the ingestion pipeline and enrichment according to some example implementations;

FIG. 3 is a flow diagram illustrating an the process of the collector within the ingestion pipeline according to some example implementations;

FIG. 4 is a flow and block diagram that illustrates the process of the enrichment module in more detail according to some example implementations;

FIG. 5 illustrates an alert sent out to stakeholders of a query that is expensive and resource intensive according to some example implementations;

FIG. 6A illustrates another flow and block diagram similar to FIG. 1, but with a query context processor according to some example implementations;

FIG. 6B illustrates a flow and block diagram that illustrates the query context processor in further detail according to some example implementations;

FIG. 7 illustrates the features of a resource intensive query according to some example implementations;

FIG. 8 illustrates a flowchart that illustrated a method of the invention according to some example implementations;

FIG. 9A is a block diagram illustrating an electronic device according to some example implementations; and

FIG. 9B is a block diagram of a deployment environment according to some example implementations.

### DETAILED DESCRIPTION

The following description describes implementations for identifying resource intensive queries that are received from a plurality of databases. The system can identify and eliminate the resource intensive queries that are critical. As such, the computing system is able to have more execution time for other queries that are less resource intensive. In addition, the system also has more resources for other queries due to less computer processing unit (cpu) execution being taken up per query. As such, the various embodiments illustrate how the efficiency and viability of the computing system can be improved by detecting and flagging resource intensive and critical queries, and also providing alerts on such queries as well.

In large scale systems, observability data on query execution statistics can be generated at a high volume for each individual database server. A mechanism that can detect, flag, and categorize resource intensive and expensive queries at the fleet level is illustrated to process data from each of the multi-tenant database servers. Expensive queries can be synonymous with resource intensive queries. The resource intensive queries can be the queries that involve higher execution times than normal, and higher execution times than most of the other queries received. Further, the resource intensive queries can take up more of the computational resources of the computing system in comparison to the other received queries, and thereby affect the functioning and viability of the computing system as well. The fleet level can be a cluster of queries that are received from a plurality of database servers that are sending the cluster of queries into the computing system or network.

When a plurality of database servers send query requests into the system, an ingestion pipeline configured within the system can receive each query. The ingestion pipeline can be configured within the computing system to intake the received queries and obtain the vital statistics for each of the received queries. The ingestion pipeline can obtain the statistics for each query at configurable intervals. The ingestion pipeline can attempt to extract keywords and metadata from each query to assist the system in identifying which query can be resource intensive. The ingestion pipeline can then push the data found on each query into a dedicated low latency data store that can be optimized for querying and analysis.

The computing system can also have an enrichment analysis module that can receive the data aggregated on each query from the ingestion pipeline. The enrichment analysis module can be configured to receive the queries from the ingestion pipeline. The enrichment analysis module can be configured to provide a detailed view of the statistics of the queries, and determine which of the queries are critical and thereby be passed onto a delivery component as a result. With the enrichment analysis, the aggregated data from the queries and data collected from each database server at a fleet level can be consolidated. A historical statistical analysis can then occur to detect, categorize and flag queries. The queries that are determined to be critical and taking up a lot of the computing resources are to be identified. The queries whose cpu footprint and execution time that has breached a configuration threshold of the computing system can be identified as critical. The cpu footprint can refer to the cpu processing power that is associated with the resource intensive query. A query that requires high cpu processing power for execution can have a high cpu footprint. The queries whose cpu footprint and execution time that has not breached the configuration threshold can be identified as non-significant. The configuration threshold can refer to predefined limits and configuration parameters of the computing system. The database servers can also have a configuration threshold as well. The enrichment analysis can include a drill-down analysis that provides detailed insights on the cpu execution time and trend for the resource intensive queries that are identified to be critical.

The flagged queries that are determined to be critical can be passed onto a delivery component. The delivery component can be configured to receive the queries identified as critical by the enrichment analysis module, and thereby generate alerts for the critical queries to enable the computing system to eliminate or filter out such critical queries. The delivery component can generate and publish alert objects based on the alerting platform's criteria. The alerts can be created for each critical and resource intensive query to alert the system to eliminate such queries. The reduction or elimination of such resource intensive queries can increase the computational efficiency of the computing system. The following embodiments illustrate in more detail the various features of the present inventive concept.

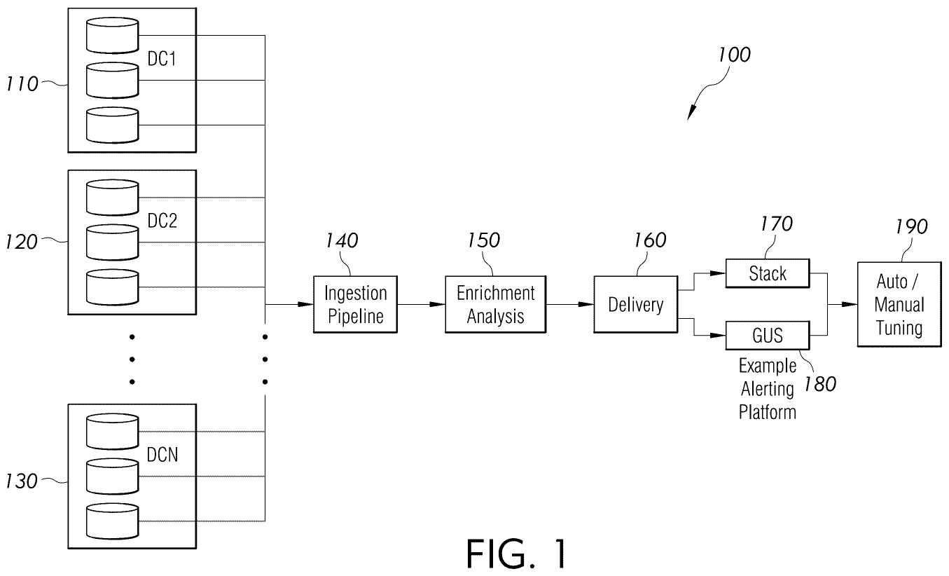

FIG. 1 depicts an exemplary implementation of a system 100 that can be implemented on a computing system. The system 100 can receive multiple queries from a plurality of database servers 110, 120, 130. The database servers 110, 120, 130 can send queries into the system 100 in multiple intervals. Many of the queries which the database servers 110, 120, 130 send can be expensive and resource intensive. The expensive and resource intensive queries can often overwhelm the system 100. Moreover, the expensive and resource intensive queries can have sub optimal plans that can cause fleet wide resource consumption regression within the system 100. The expensive and resource intensive queries can have sub optimal plans because of the greater than normal cpu execution time, and computational resources that are required for their execution. Threats to platform availability within the system 100 can also occur. The resource intensive queries can have higher cpu execution times than the other queries, which greatly affect the platform availability. An ingestion pipeline 140 can be configured to receive the queries from the database servers 110, 120, 130. The ingestion pipeline 140 can efficiently capture and aggregate each query. The ingestion pipeline 140 can also identify the execution plan statistics for each query at multiple time intervals. Further, the ingestion pipeline 140 can extract keywords and metadata from the text of the queries to identify if the queries are expensive and resource intensive. The ingestion pipeline 140 can then push the queries into a dedicated low-latency data store that is optimized for rapid querying and analysis. The ingestion pipeline 140 can perform an initial task of identifying what keywords and metadata from each query can be characteristics of resource intensive queries.

Referring again to FIG. 1, an enrichment analysis module 150 can consolidate the aggregated queries from the ingestion pipeline 140. The enrichment analysis module 150 can consolidate the aggregated queries and plan data collected from each database server 110, 120, 130 at a fleet level. The enrichment module 150 can then apply historical statistical analysis to detect, categorize, and flag the queries that are expensive and resource intensive at the fleet level, individual server level, or user level. The enrichment module 150 can determine if any of the resource intensive queries are either critical or non-significant. The enrichment module can determine if the cpu footprint and execution time for the resource intensive queries have breached the configuration threshold. For each query flagged to be resource intensive or expensive, a drill-down analysis can be performed to capture detailed insights from the queries' execution profile. The drill-down analysis can show a detailed statistical assessment of each of the resource intensive queries. The detailed statistical assessment can include the cpu projection trend, the average cpu time per execution, and the total cpu execution time for each resource intensive query.

In FIG. 1, a delivery component 160 can generate and publish alerts of the flagged and analyzed queries. The delivery component 160 can generate and publish alert objects of the flagged queries based on the alerting platform's criteria. The alerts are provided for each expensive and resource intensive query that is determined to be critical and significant. Notifications of the alerts can be sent to relevant stakeholders using remaining storage space or a slack 170 and/or grand unified system (GUS) 180. Auto manual tuning 190 with respect to the alerts can also be applied. The published alerts can notify the system 100 of which queries to reduce or eliminate to increase the platform availability of the system 100.

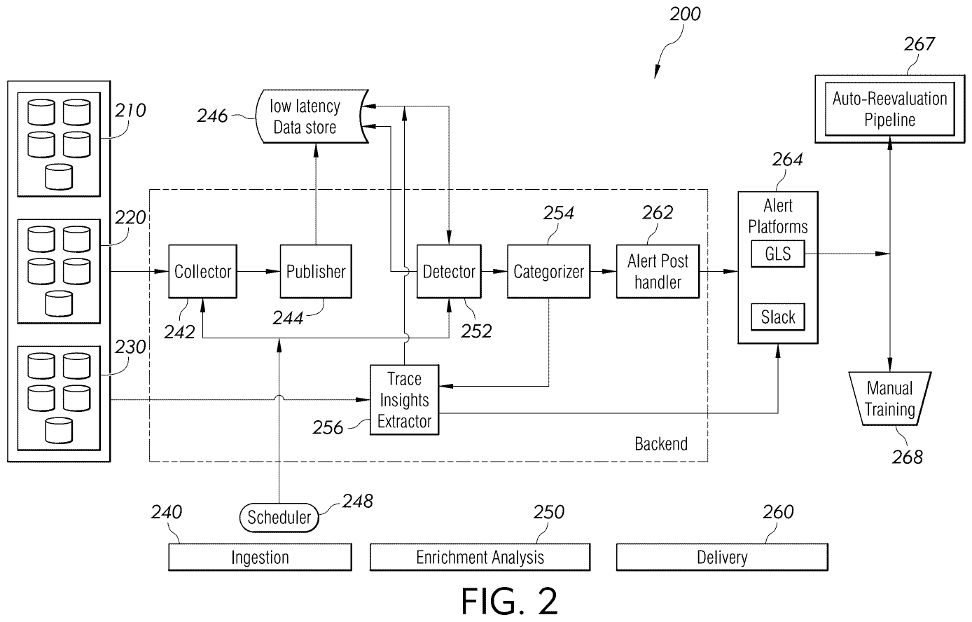

Referring to FIG. 2, a more detailed view of FIG. 1 is illustrated with the system 200 in FIG. 2. The system includes database servers 210, 220, 230 sending queries. The ingestion pipeline 240 can receive the queries. The ingestion pipeline 240 can include a collector 242, publisher 244, low latency data store 246, and scheduler 248. The collector 242 can perform tokenization and cleaning of each query. With tokenization and cleaning, the query text can be broken into distinct segments and then refined for accuracy and relevance. The collector 242 can also perform filtering and classification. With filtering and classification, tokens can be filtered for stopwords, and the queries can be placed into a category. The stopwords can be common and insignificant words that can be filtered out at various intervals. The collector 242 may also perform keyword extraction of each query, wherein significant keywords within each query can be identified. The keywords can assist the system 200 to identify which of the queries received can be resource intensive. The publisher 244 can create and distribute content within the system 200. The low latency data store 246 can provide fast access to data and minimize a delay in a request for the data. The scheduler 248 can determine an order of tasks to be performed within the system 200.

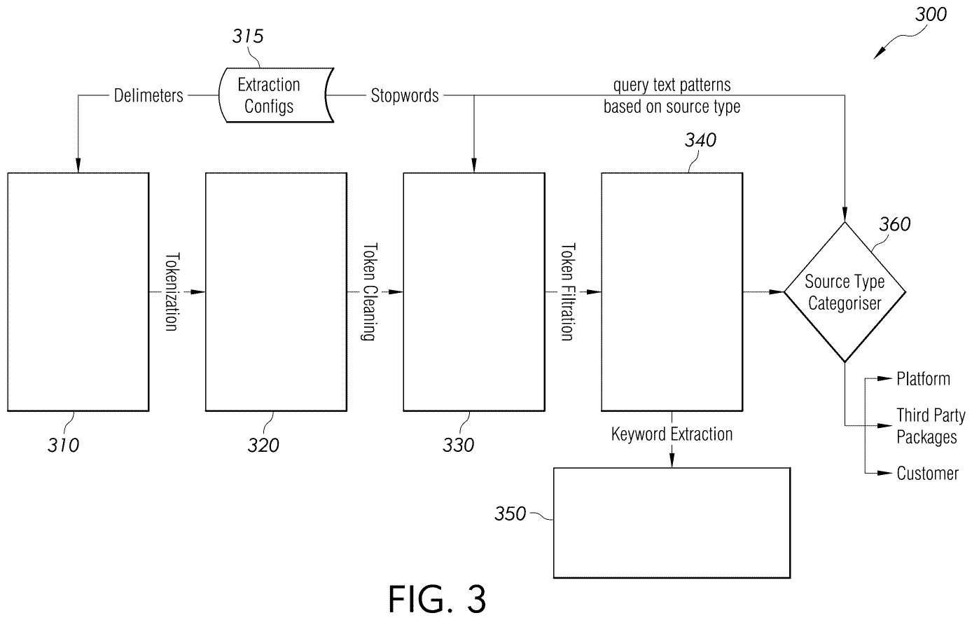

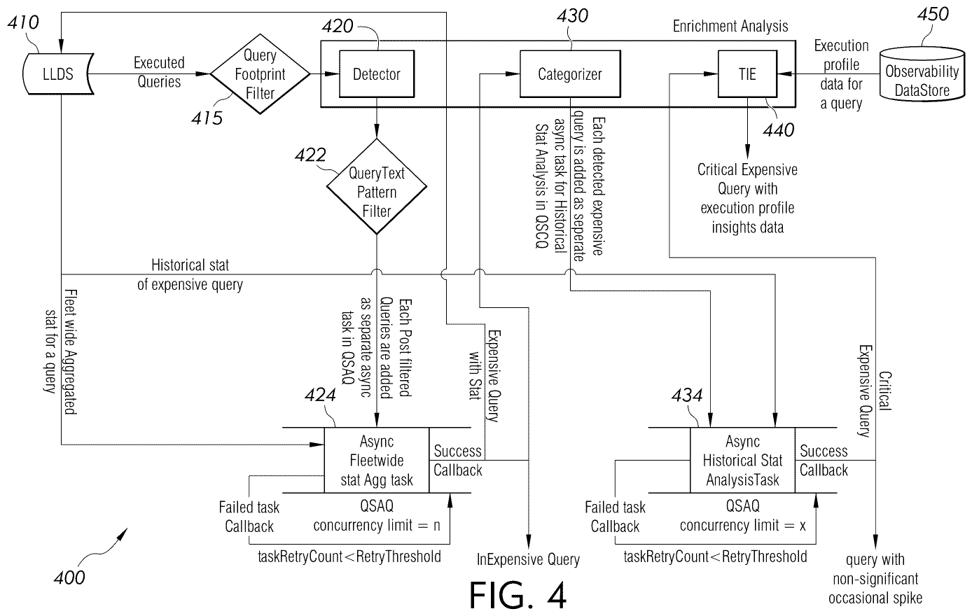

In FIG. 2, the enrichment analysis module 250 can include a detector 252, categorizer 254, and trace insights extractor 256. The detector 252 can perform a query plan footprint to filter out queries whose cpu footprint has not breached a configuration threshold. The detector 252 can also perform query cpu per execution to filter out the queries whose cpu time per execution has not breached the configuration threshold. Further, the detector can also perform query text analysis using a whitelisted pattern, wherein the queries with a certain text pattern are filtered out. The categorizer 254, based on the occurrence and captured footprint, can categorize the resource intensive queries as either critical or non-significant. The categorizer 254 can categorize the resource intensive queries as either critical or non-significant based on whether the cpu footprint or cpu execution of those resource intensive queries breached the configuration threshold. The queries with the cpu footprint and cpu execution that breached the configuration threshold can be categorized as critical, while the queries with the cpu footprint and cpu execution that did not breach the configuration threshold can be classified as non-significant. For the resource intensive and critical queries, the trace insights extractor 256 can capture insights on the queries to tune the queries automatedly or manually. Moreover, a more detailed analysis of the various components of the ingestion pipeline 240 and enrichment module 250 are illustrated in FIGS. 3-4. The system 200 also illustrates the delivery component 260. The delivery component 260 can include an alert post handler 262, alert platforms 264 that include GUS and slack, an auto-remediation pipeline 267, and manual tuning 268. The alert post handler 262 can receive an alert notification and transmit the alert notification. The alert platforms 264 can facilitate the generation of the alerts. The auto-remediation pipeline 267 can assist with resolving issues in transmitting the alerts. The manual tuning 268 can adjust any variables needed to enable the alerts to be generated and provided. The delivery component 260 can generate the alerts for the system 200 to identify which resource intensive queries to reduce or eliminate. The alerts can show the statistics of the critical and resource intensive queries.

FIG. 3 depicts a collector system 300 via a flow diagram that is a more detailed illustration of the process of the ingestion pipeline illustrated in FIGS. 1-2. The ingestion pipeline can include the collector system 300 that performs tokenization, cleaning, filtering, classification, and keyword extraction. With tokenization, the query text from each query can be tokenized using a configurable set of delimiters to break the text of each query into distinct segments. The distinct segments can then lead to the cleaning process. The cleaning process can involve the tokens being refined by regular expressions to ensure accuracy and relevance. The tokens can then be filtered. With filtering, the tokens can be filtered based on a configurable list of stopwords or common words. As previously mentioned, the stopwords can be common words that do not provide any important meaning or information. The stopwords can be tailored to the specific database technology in use. The filtering can eliminate common but uninformative terms within each query, thereby enhancing the remaining tokens that are in use.

In FIG. 3, the classification can use refined tokens. With the refined tokens, each query can be classified into several categories such as “customer,” “platform,” or “packages,” which can be collectively referred to as the “QuerySourceType” or Query Source Type. The keyword extraction can apply configurable weights based on platform to the final list of tokens to identify the significant keywords within each query. The keywords can assist the system 300 in finding out the implemented functionality at the application layer that sourced out the query. The keywords can be referred to as “Query SourceContext” or Query Source Context. Moreover, the Query Source Context can correlate application implementations with database resource consumption. As such, application layer implementations and database resource consumption at the fleet and individual database server level can be captured through the Query Source Context. The Query Source Context can enable the system 300 to flag unoptimized application layer implementations across diverse applications that may be having a significant impact on database server availability and resources. A natural language process (NLP) based similarity model can use the Query Source Context to achieve high scalability and enhanced accuracy for mapping pre-modified and post-modified queries to streamline the tracking of query performance after any changes. With high scalability, the system 300 can continue to perform efficiently with an increased workload and consumption. The Query Source Context can also help in comparing the database footprint of application layer implementations across multiple database servers. Further, the Query Source Context can assist in potentially identifying issues with database server migrations, wherein data and schema can be transferred from one database server to another database server.

Referring again to FIG. 3 of the collector system 300, at 310, the tokenization can occur. Delimiters and extraction codings 315 can be applied at 310 to section the text of each query into distinct segments. At 320, the cleaning can occur. Moreover, the tokens can be refined with regular expressions to ensure accuracy and relevance. Then, at 330, the filtering can occur. With the filtering, a configurable list of stopwords can be used to filter out the uninformative and common terms within each query. The filtering of the stopwords can assist the collector system 300 with ultimately extracting the keywords and metadata of the queries. At 340, the classification can occurs with the source type categorizer. Query text patterns based on source type are illustrated. Each query can be classified into several categories (platform, third party packages, customer) which can be collectively referred to as Query Source Types.

In FIG. 3, at 350, keyword extraction can occur. The configurable weights based on the platform can be applied to the remaining tokens to identify the significant keywords. Identifying the keywords can determine the implemented functionality at the application layer that sourced out the query. The keywords can thereby be referred to as Query Source Context. At 360, a source type categorizer can include platforms, third party packages, and customers. Overall, the process 300 can identify the keywords to be extracted from the received queries to identify the resource intensive queries. The keywords can be referred to as Query Source Context that illustrate the cpu execution time and database footprint or similar statistics that can indicate resource intensive queries.

In FIG. 4, a flow diagram 400 that provides a more detailed explanation of the enrichment analysis module of FIGS. 1-2 is illustrated. The three main components of the enrichment analysis module can include a detector, categorizer, and trace sights extractor. The detector can detect expensive queries that ran in a given time interval in at least one of the database servers. The categorizer can assign a severity to all of the expensive queries. As such, the resource intensive queries with a cpu footprint and cpu execution that breached the configuration threshold can be identified as critical. The resource intensive queries with a cpu footprint and cpu execution time that did not breach the configuration threshold can be identified as non-significant. An alert may only be provided for the queries which are identified as critical. The trace insights extractor can capture useful insights from the query execution profile that can help provide automated or manual tuning of the queries.

Referring again to FIG. 4, a low latency data store 410 is shown. The low latency data store 410 can provide fact access to data minimize any delays between a request for data and providing the data in response to the request. The low latency data store 410 can send executed queries to a query footprint filter 415. The query footprint filter 415 is a filter that can refine search results by applying additional constraints in addition to the keywords or Query Source Context to make the search within the queries to be more precise. The low latency data store 410 can also send a fleet wide aggregated stat for a query to a query stat aggregation queue 424. The query stat aggregation queue 424 can temporarily store incoming queries to allow the system 400 to collect and aggregate statistical information about the incoming queries. The executed queries from the query footprint filter 415 can be passed on to a detector 420. The detector 420 can apply a query plan footprint in which it filters out queries whose corresponding cpu footprint has not breached a configuration threshold in any of the database servers. The detector 420 can also filter out queries having certain pattern in its text. The results from the detector 420 can be passed onto a query text pattern filter 422, which can filter certain text from the queries. The queries can then be passed onto the query stat aggregation queue 424. The detector 420 can be in place to filter out the resource intensive queries that may not be determined to be critical.

In FIG. 4, the flow diagram 400 can move onto the categorizer 430. The role of the categorizer 430 can be to detect expensive queries based on certain intervals. Nevertheless, for an expensive query, current collected footprint might be an anomaly or not an unusual behavior. Some anomalies cannot be ignored if the cpu footprint breaches the configuration threshold. The categorizer 430 can identify the severity of the expensive and resource intensive queries. The categorizer 430 can categorize such queries as critical or insignificant. Each detected expensive and resource intensive query can have its severity determined using a historical stat analysis task 434. As such, the at least one query determined to be resource intensive can be categorized as critical by using the historical stat analysis task 434, which can assist the categorizer 430 in categorizing the queries. A determination can be made as to which queries breached the configuration threshold of the computing system. The tasks can be carried out asynchronously. The insignificant or non-significant queries can be ignored while the queries determined to be critical can be passed onto a trace insights extractor 440. The trace insights extractor 440 can function to ultimately pass the critical queries to a delivery component that can generate alerts that illustrate the detailed statistics of the critical queries. When the alerts are generated, the computing system can then filter out the critical queries as a result.

In FIG. 4, the role of the trace insights extractor 440 can be to identify the resource intensive queries with the highest footprint contribution to total fleet level footprint. The trace insights extractor 440 can also identify the resource intensive queries with the highest execution time. The trace insights extractor 440 can also identify the resource intensive queries based on cpu contribution in relation to the database servers cpu. The trace insights extractor 440 identifying the specific statistics of the resource intensive queries can assist the system with identifying the specific statistics of resource intensive and critical queries. The results of the trace insights extractor 440 can then be passed onto an observability data store 450 and then to the delivery component. The delivery component can generate the alerts which the system can see to thereby reduce or filter out such critical and resource intensive queries. As mentioned above, the alerts can also illustrate the cpu statistics of the critical and resource intensive queries as well.

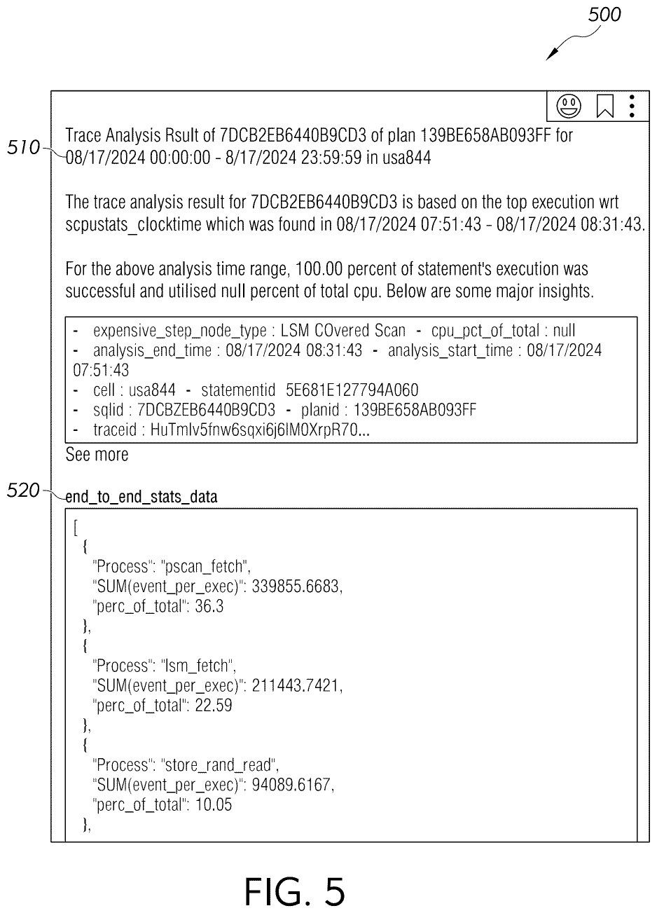

In FIG. 5, an alert 500 is illustrated. The alert 500 can be generated to illustrate the detailed statistics for the critical query that is being displayed. For the queries that are categorized as critical by the detector, the queries are passed onto the trace insights extractor. The trace insights extractor can identify the critical and resource intensive queries with the highest footprint contribution, execution time, cpu contribution in relation to the cpu contribution of the database servers. The results can be passed onto a delivery component which can then publish the alert 500. The alert 500 can include a trace analysis result 510 and end to end stats data 520. The delivery component can generate and publish alert objects for the critical queries based on the alerting platform's criteria. The alert 500 and other alerts can be created for each expensive and resource intensive critical query with trace insights, and provide actionable notifications to relevant stakeholders. Moreover, the system can thereby take necessary steps to reduce or eliminate, or filter out such critical queries that affect the system's computational efficiency.

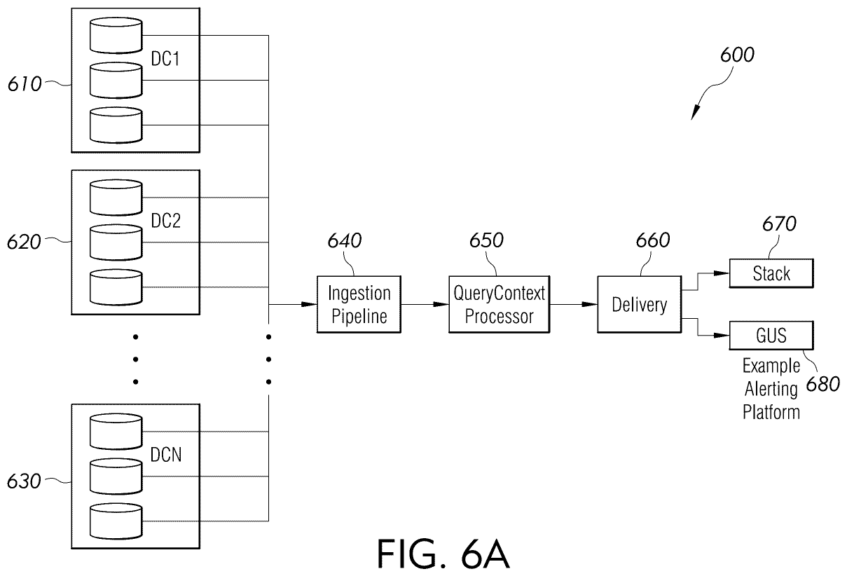

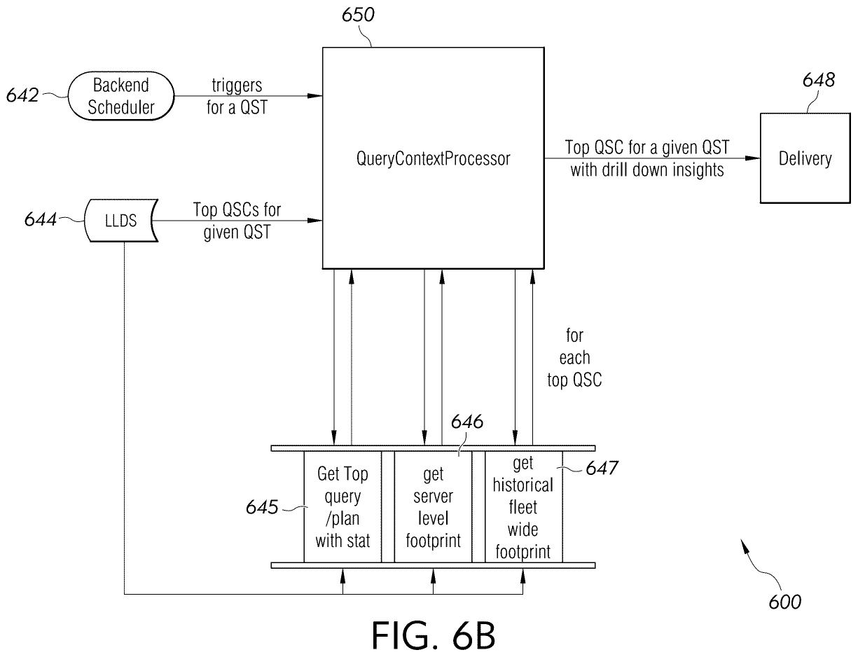

Referring to FIG. 6A, another system 600 is shown similar to FIG. 1. The system 600 can include a plurality of database servers 610, 620, and 630. The system 600 can also include an ingestion pipeline 640 substantially similar to what is previously described above. The various components of the system 600 can perform tasks and be configured to perform those tasks in a substantially similar manner as to what is described above in FIG. 1. In addition, the system 600 can also include a query context processor 650, delivery component 660, a slack 670, and a GUS 680. The system 600 can be implemented to identify which received resource intensive queries are critical, and which should be eliminated from the system 600.

In FIG. 6A, the database servers 610, 620, 630, can send queries into the ingestion pipeline 640. The collector within the ingestion pipeline 640 can perform the various tasks of tokenization, cleaning, filtering, classification, and keyword extraction. The collector in the ingestion pipeline 640 can use extraction algorithms to extract significant keywords and metadata from the query text for each query. Based on the platform, the collector's extraction algorithm weights can be configured to extract a query source context and query source type. A publisher within the ingestion pipeline 640 can then store the Query Source Context (QSC) and the Query Source Type (QST) in a dedicated low latency store.

In FIG. 6A, the query source context processor 650 can then utilize the results from the ingestion pipeline 640 to aggregate the query statistics across the fleet or individual server. Moreover, the query source context processor 650 can be configured to aggregate the query statistics sent by each of the database servers. Due to the aggregation, the top QSC's for each QST can be identified on a fleet wide or individual server basis. Moreover, to refine accuracy, the query source context processor 650, in some embodiments, can use a whitelist filter that excludes expected high-footprint functionalities. For each top QSC, the QSC can offer a drill-down view that includes time series data of fleet wide footprint. The drill-down view can also include top queries and plans that provide detailed statistics on the most resource intensive queries and their execution plans under the QSC. The drill-down view can also provide a server-level footprint that includes a breakdown of the QSC's resource consumption at the individual server level. The drill-down view can provide the detailed statistics on the queries to enable critical queries to be identified. The query source context processor 650 can also interact with the delivery component 660 to enable the delivery component 660 to provide alerts on the critical queries using the slack 670 and GUS 680.

Referring to FIG. 6B, a system 600 that provides another detailed explanation of FIG. 6A is described. A backend scheduler 642 can provide triggers for a QST to the query source context processor 650. The backend scheduler 642 can be responsible for managing the execution of tasks or jobs on the backend of the system 600. The low latency data store 644 can also provide the top QSC's for a given QST to the query source context processor 650. The query source context processor 650 can then provide the drill-down view 645 for each top QSC. In other words, the drill-down view 645 can include top queries and plans that provide detailed statistics on the most resource intensive queries and their execution plans under the QSC. The drill-down view can also provide a server-level footprint that includes a breakdown of the QSC's resource consumption at the individual server level. The drill-down view 645 can further include a historical fleet wide footprint.

In FIG. 6B, the drill-down view 645 provides the detailed statistics to identify which of the queries can potentially be critical and resource intensive. The query source context processor 650 can also provide the top QSC for a given QST with the drill down insights and analysis to the delivery component 660. The top QSC with the given QST can include execution time and resource consumption that can be at critical levels. The delivery component 660 can include in the alerts of a critical query the drill-down insights for the top QSC for a given QST which illustrate the statistics of such a critical query.

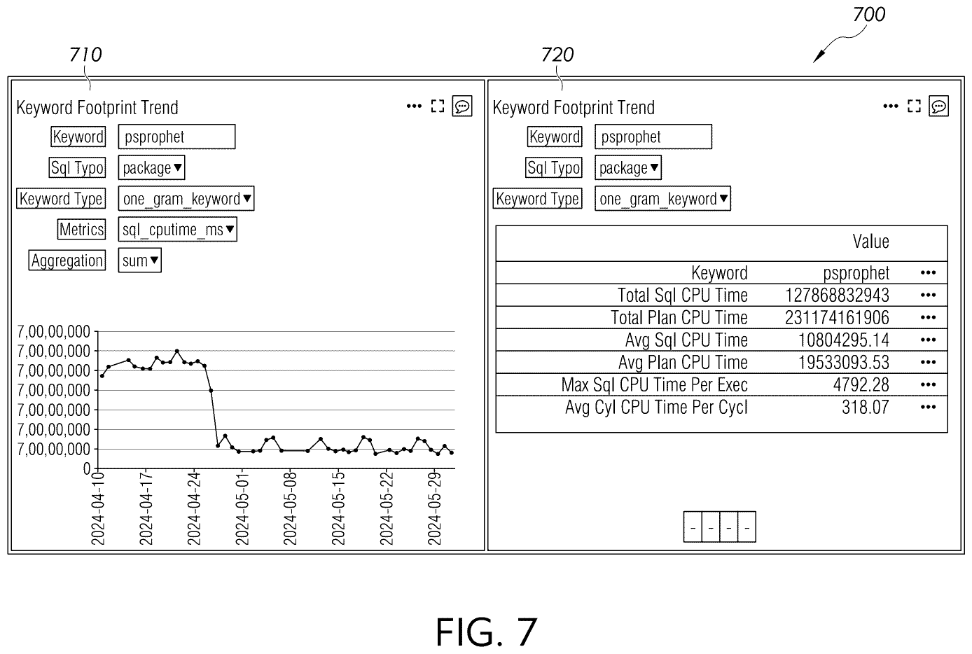

Referring to FIG. 7, an alert 700 is provided that is produced from the delivery component described previously in in FIGS. 1, 2, and 6A-6B. The alert 700 can include a key footprint trend 710 and keyword's footprint 720. The key footprint trend 710 can include a graphical analysis of the cpu resources required over multiple time intervals. The time intervals can span a period of months over the same calendar year. The keyword's footprint 720 can provide statistics of the total cpu time, average cpu time, and maximum cpu time per execution. The extracted keyword or keywords can also be shown in both the key footprint trend 710 and keyword's footprint 720. The alert 700 can provide a graphical illustration of the cpu time and the statistics behind the cpu time for a critical query to notify the system and any relevant stakeholders of the resource consumption of the critical query.

In FIG. 7, the alert 700 can provide the detailed statistics of the critical and resource intensive query. The system can be aware of which queries have a high cpu time over multiple time intervals from the key footprint trend 720 over the course of a calendar year. Further, the system can be aware of which critical queries have a high total cpu time, average cpu time, and maximum cpu time per execution. The system can become aware of which critical queries affect the viability and processing of the system when queries are sent from the database servers. The system can also be aware of how much platform availability can become available if such critical queries are eliminated.

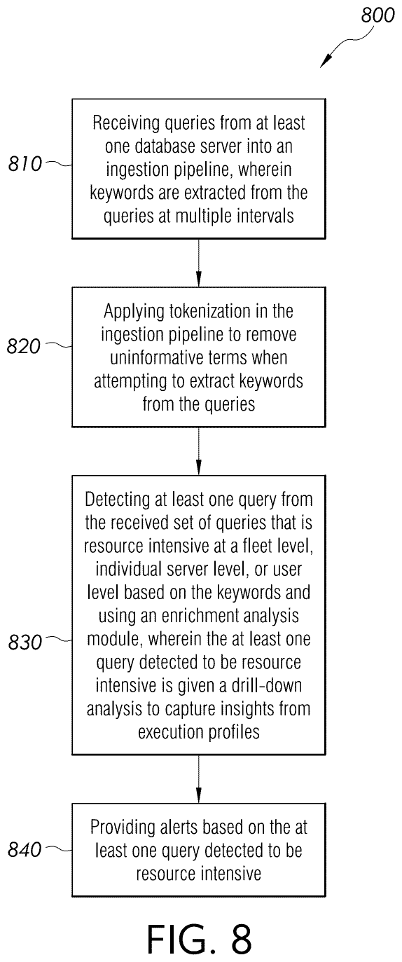

Referring to FIG. 8, a process 800 is illustrated in which queries from a plurality of database servers can be received by a computing system. The queries can be passed through an ingestion pipeline, and an enrichment analysis module. The computing system can identify the statistics of the queries. Statistics such as the cpu footprint and cpu execution times of the queries can be identified by the computing system in various intervals.

At step 810, the computing system can receive queries from at least one database server into an ingestion pipeline within a computing device. The keywords can be extracted from the queries at multiple intervals within the ingestion pipeline. The keywords can indicate the statistics of the received queries.

Next, at step 820, tokenization can be applied in the ingestion pipeline to remove uninformative terms. As such, configurable weights can be applied to a list of tokens to extract the keywords from the at least one query. The tokens can be filtered to remove uninformative terms in the process of extracting keywords. The tokens can thereby be filtered to eliminate non-relevant terms. In addition, the tokens can also be refined to increase accuracy and relevance when extracting keywords. The uninformative terms including the stopwords which do not reveal any significant information can be removed to attempt to identify any queries which could end up being resource intensive and critical.

At step 830, at least one query can be detected from the received set of queries to be resource intensive at a fleet level, individual server level, or user level based on the keywords and using an enrichment analysis module. In other embodiments, fleet level data can be aggregated to identify whether other queries are resource intensive as well. In addition, the at least one query detected to be resource intensive is given a drill-down analysis to capture insights from execution profiles. The drill-down analysis can illustrate the statistics of the resource intensive query. Further, the least one query can be added to a query severity categorization queue (QSCQ) to categorize its severity. If the statistics of the resource intensive query breach the configuration threshold, the query can be determined to be critical. Whether the at least one query is critical or non-significant can be based on occurrence and captured footprint as well. If the statistics of the resource intensive query do not breach the configuration threshold, the query can be determined to be non-significant. As such, queries with an execution plan footprint that has not breached a configuration threshold in any of the database servers can be filtered out.

Then, at step 840, alerts can be provided based on the at least one resource intensive query. Moreover, alerts can be provided for the at least one resource intensive query that is determined to be critical. The alert can provide the statistics of the critical resource intensive query such as cpu execution and cpu footprint to alert the system to filter out or delete such a query as a result.

The exemplary implementations described above can provide technical benefits to the computing system. The computing system can function more efficiently by systemically addressing the critical queries. As such, when the computing system is trained to address the critical queries, and eliminate the critical queries, the computing system can have more resources to function more efficiently. The computing system can spend less execution time per query in the absence of the resource intensive and critical queries. Further, the computing system can spend more resources on the queries which do not take up as much cpu execution time or which are not resource intensive.

The computing system can continuously receive queries from a plurality of the database servers. The ingestion pipeline within the computing system can process each query and extract the significant keywords and metadata from each query. Stopwords can be pulled from each query to enable the ingestion pipeline to more efficiently identifying the keywords which can provide insight into which queries can be resource intensive and critical. The ingestion pipeline can the push the aggregated data from each query into a dedicated low latency data store for rapid querying and analysis.

The analysis can then pass onto the enrichment module. With the enrichment analysis, the enrichment module can consolidate the aggregated query and plan data collected from each of the database servers at configurable intervals. Historical statistical analysis can then be applied. The historical statistical analysis can detect, categorize, and flag queries that are expensive and resource intensive at the fleet level, individual server level, or user level. For each flagged query, the enrichment module can do a drill-down analysis to capture detailed insights from the queries execution profile. The drill-down view can provide the detailed statistics of the queries. Moreover, the queries can be categorized as critical or non-significant. The queries which are non-significant can be ignored while the queries categorized as critical can be passed onto the delivery component.

The delivery component can receive the queries that are categorized as critical. The delivery component can generate and publish alert objects based on the alerting platform's criteria. Alerts can then be created for each identified critical and resource intensive query accordingly. The alerts can illustrate the statistics of the critical queries such as their footprint trend that has or can occur over a period of time. The alerts can also illustrate the overall footprint of the critical query that illustrates the average cpu time, total cpu time, and maximum cpu time per execution. As a result, the system can be aware of how much computational resources are being devoted to such critical queries. In response, the computing system can perform actions to improve the platform availability, the computational resources, and thereby the computational efficiency of the system.

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals—such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

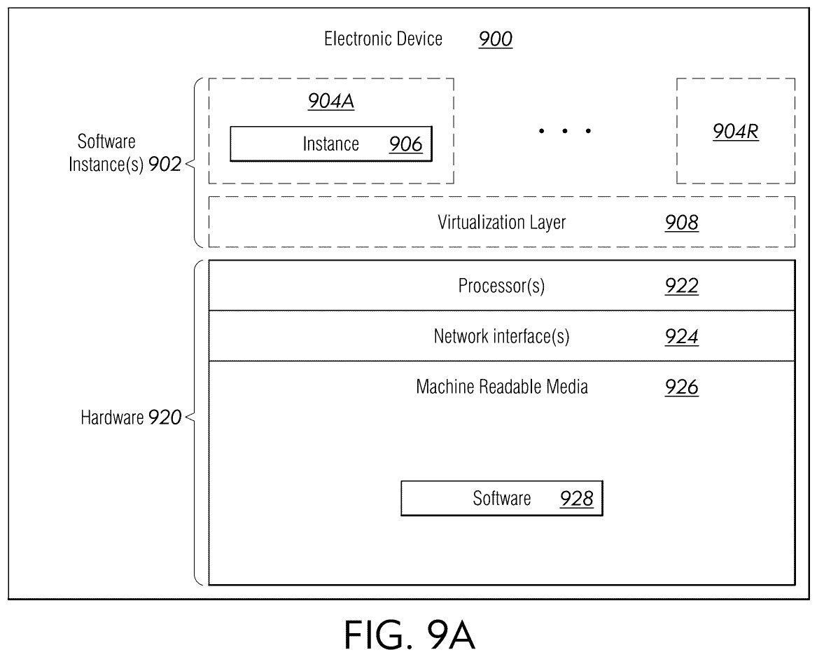

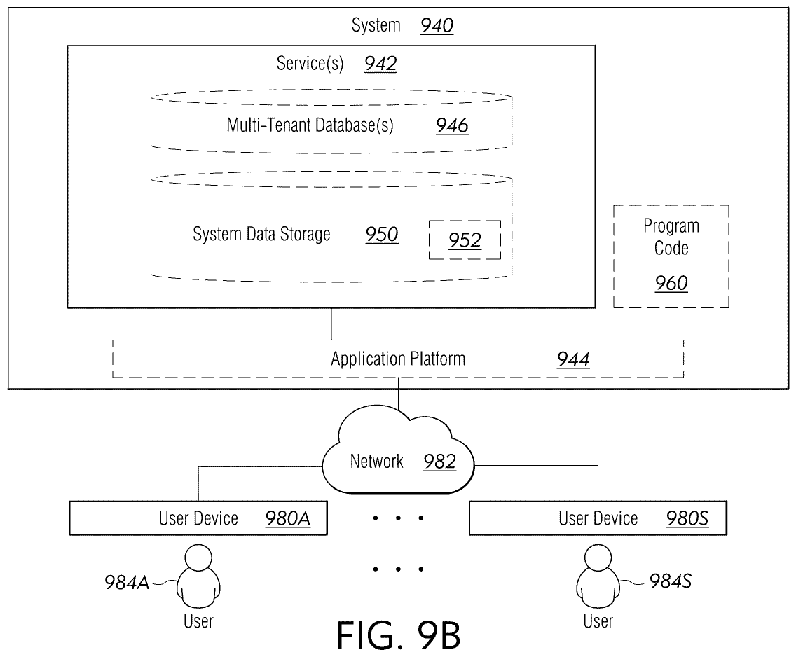

FIG. 9A is a block diagram illustrating an electronic device 900 according to some example implementations. FIG. 9A includes hardware 920 comprising a set of one or more processor(s) 922, a set of one or more network interfaces 924 (wireless and/or wired), and machine-readable media 926 having stored therein software 928 (which includes instructions executable by the set of one or more processor(s) 922). The machine-readable media 926 may include non-transitory and/or transitory machine-readable media. Each of the previously described clients, web application firewall services and client-side services may be implemented in one or more electronic devices 900. In one implementation: 1) each of the clients is implemented in a separate one of the electronic devices 900 (e.g., in end user devices where the software 928 represents the software to implement clients to interface directly and/or indirectly with the web application firewall services and/or client-side services (e.g., software 928 represents a web browser, a native client, a portal, a command-line interface, and/or an application programming interface (API) based upon protocols such as Simple Object Access Protocol (SOAP), Representational State Transfer (REST), etc.)); 2) the web application firewall services and/or client-side services is implemented in a separate set of one or more of the electronic devices 900 (e.g., a set of one or more server devices where the software 928 represents the software to implement the web application firewall services and/or client-side services); and 3) in operation, the electronic devices implementing the clients and the web application firewall services and/or client-side services would be communicatively coupled (e.g., by a network) and would establish between them (or through one or more other layers and/or or other services) connections for submitting requests to the web application firewall services and/or client-side services. Other configurations of electronic devices may be used in other implementations.

During operation, an instance of the software 928 (illustrated as instance 906 and referred to as a software instance; and in the more specific case of an application, as an application instance) is executed. In electronic devices that use compute virtualization, the set of one or more processor(s) 922 typically execute software to instantiate a virtualization layer 908 and one or more software container(s) 904A-904R (e.g., with operating system-level virtualization, the virtualization layer 908 may represent a container engine (such as Docker Engine by Docker, Inc. or rkt in Container Linux by Red Hat, Inc.) running on top of (or integrated into) an operating system, and it allows for the creation of multiple software containers 904A-904R (representing separate user space instances and also called virtualization engines, virtual private servers, or jails) that may each be used to execute a set of one or more applications; with full virtualization, the virtualization layer 908 represents a hypervisor (sometimes referred to as a virtual machine monitor (VMM)) or a hypervisor executing on top of a host operating system, and the software containers 904A-904R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 928 is executed within the software container 904A on the virtualization layer 908. In electronic devices where compute virtualization is not used, the instance 906 on top of a host operating system is executed on the “bare metal” electronic device 900. The instantiation of the instance 906, as well as the virtualization layer 908 and software containers 904A-904R if implemented, are collectively referred to as software instance(s) 902.

Alternative implementations of an electronic device may have numerous variations from that described above. For example, customized hardware and/or accelerators might also be used in an electronic device.

FIG. 9B is a block diagram of a deployment environment according to some example implementations. A system 940 includes hardware (e.g., a set of one or more server devices) and software to provide service(s) 942, including web application firewall services and/or client-side services. In some implementations the system 940 is in one or more datacenter(s). These datacenter(s) may be: 1) first party datacenter(s), which are datacenter(s) owned and/or operated by the same entity that provides and/or operates some or all of the software that provides the service(s) 942; and/or 2) third-party datacenter(s), which are datacenter(s) owned and/or operated by one or more different entities than the entity that provides the service(s) 942 (e.g., the different entities may host some or all of the software provided and/or operated by the entity that provides the service(s) 942). For example, third-party datacenters may be owned and/or operated by entities providing public cloud services (e.g., Amazon. com, Inc. (Amazon Web Services), Google LLC (Google Cloud Platform), Microsoft Corporation (Azure)).

The system 940 is coupled to user devices 980A-980S over a network 982. The service(s) 942 may be on-demand services that are made available to one or more of the users 984A-984S working for one or more entities other than the entity which owns and/or operates the on-demand services (those users sometimes referred to as outside users) so that those entities need not be concerned with building and/or maintaining a system, but instead may make use of the service(s) 942 when needed (e.g., when needed by the users 984A-984S). The service(s) 942 may communicate with each other and/or with one or more of the user devices 980A-980S via one or more APIs (e.g., a REST API). In some implementations, the user devices 980A-980S are operated by users 984A-984S, and each may be operated as a client device and/or a server device. In some implementations, one or more of the user devices 980A-980S are separate ones of the electronic device 900 or include one or more features of the electronic device 900.

In some implementations, the system 940 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants. In one implementation, the system 840 is a multi-tenant cloud computing architecture supporting multiple services, such as one or more of the following types of services: Customer relationship management (CRM); Configure, price, quote (CPQ); Business process modeling (BPM); Customer support; Marketing; External data connectivity; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“app store”); Data modeling; Authorization; Authentication; Security; and Identity and access management (IAM). For example, system 940 may include an application platform 944 that enables PAAS for creating, managing, and executing one or more applications developed by the provider of the application platform 944, users accessing the system 940 via one or more of user devices 980A-980S, or third-party application developers accessing the system 940 via one or more of user devices 980A-980S.

In some implementations, one or more of the service(s) 942 may use one or more multi-tenant databases 946, as well as system data storage 950 for system data 952 accessible to system 940. In certain implementations, the system 840 includes a set of one or more servers that are running on server electronic devices and that are configured to handle requests for any authorized user associated with any tenant (there is no server affinity for a user and/or tenant to a specific server). The user devices 980A-980S communicate with the server(s) of system 940 to request and update tenant-level data and system-level data hosted by system 940, and in response the system 940 (e.g., one or more servers in system 940) automatically may generate one or more Structured Query Language (SQL) statements (e.g., one or more SQL queries) that are designed to access the desired information from the multi-tenant database(s) 946 and/or system data storage 950.

In some implementations, the service(s) 942 are implemented using virtual applications dynamically created at run time responsive to queries from the user devices 980A-980S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 960 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 944 includes an application setup mechanism that supports application developers' creation and management of applications, which may be saved as metadata by save routines. Invocations to such applications, including the web application firewall services and/or client-side services, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 982 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a third Generation Partnership Project (3GPP) protocol, a fourth generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 940 and the user devices 980A-980S.

Each user device 980A-980S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 940. For example, the user interface device can be used to access data and applications hosted by system 940, and to perform searches on stored data, and otherwise allow one or more of users 984A-984S to interact with various GUI pages that may be presented to the one or more of users 984A-984S. User devices 980A-980S might communicate with system 940 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 980A-980S might include an HTTP client, commonly referred to as a “browser,” for sending and receiving HTTP messages to and from server(s) of system 940, thus allowing users 984A-984S of the user devices 980A-980S to access, process and view information, pages and applications available to it from system 940 over network 982.

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting. Accordingly, details of the exemplary implementations described above should not be read into the claims absent a clear intention to the contrary.

1. A method for identifying resource intensive queries, the method comprising:
receiving queries from at least one database server into an ingestion pipeline within a computing device, wherein keywords are extracted from the queries at multiple intervals;
applying tokenization in the ingestion pipeline to remove uninformative terms when attempting to extract keywords from the queries;
detecting at least one query from the received set of queries that is resource intensive at a fleet level, individual server level, or user level based on the keywords and using an enrichment analysis module, wherein the at least one query detected to be resource intensive is given a drill-down analysis to capture insights from execution profiles, wherein the enrichment analysis module performs a historical statistical analysis to detect, flag, and categorize each query and identifies which queries with a cpu footprint and execution time that have breached a configuration threshold and a drill down analysis to identify a cpu projection trend and average cpu time per execution; and
providing alerts based on the at least one query detected to be resource intensive.

2. The method of claim 1, further comprising:
applying configurable weights to a list of tokens to extract the keywords from the at least one query.

3. The method of claim 2, further comprising:
filtering the tokens to remove uninformative terms in the process of extracting keywords.

4. The method of claim 2, further comprising:
refining the tokens to increase accuracy and relevance in relation to an extracting of keywords.

5. The method of claim 1, further comprising:
filtering the queries with an execution plan footprint that has not breached a configuration threshold in any of the database servers.

6. The method of claim 1, further comprising:
aggregating fleet level data to identify whether other queries are resource intensive.

7. The method of claim 1, further comprising:
determining whether the at least one query is critical or non-significant based on occurrence and captured footprint.

8. The method of claim 1, further comprising:
adding the least one query is to a query severity categorization queue (QSCQ) to categorize its severity.

9. At least one non-transitory machine-readable storage medium that provides instructions that, when executed by at least one processor, are configurable to cause the at least one processor to perform operations comprising;
receiving queries from at least one database server into an ingestion pipeline within a computing device, wherein keywords are extracted from the queries at multiple intervals;
applying tokenization in the ingestion pipeline to remove uninformative terms when attempting to extract keywords from the queries;
detecting at least one query from the received set of queries that are resource intensive at a fleet level, individual server level, or user level based on the keywords and using an enrichment analysis module, wherein the at least one query detected to be resource intensive is given a drill-down analysis to capture insights from execution profiles, wherein the enrichment analysis module performs a historical statistical analysis to detect, flag, and categorize each query and identifies which queries with a cpu footprint and execution time that have breached a configuration threshold and a drill down analysis to identify a cpu projection trend and average cpu time per execution; and
providing alerts based on the at least one query detected to be resource intensive.

10. The at least one non-transitory machine-readable storage medium of claim 9, wherein the queries are tokenized with a set of delimiters to identify segments of the queries.

11. The at least one non-transitory machine-readable storage medium of claim 9, wherein tokens within the queries are filtered to eliminate non-relevant terms.

12. The at least one non-transitory machine-readable storage medium of claim 9, wherein weights are assigned to tokens within the queries to identify keywords within the queries.

13. The at least one non-transitory machine-readable storage medium of claim 9, wherein a collector within ingestion pipeline filters tokens based on a list of stopwords to eliminate uninformative terms.

14. The at least one non-transitory machine-readable storage medium of claim 9, wherein a detector within the enrichment module filters out the queries with an execution time that has not breached a configuration threshold.

15. The at least one non-transitory machine-readable storage medium of claim 9, wherein a categorizer within the enrichment module identifies whether the at least one resource intensive query is critical or non-significant.

16. The at least one non-transitory machine-readable storage medium of claim 9, wherein a trace insights extractor within the enrichment module identifies an execution time for the at least one resource intensive query.

17. A computing device comprising:
at least one non-transitory machine-readable storage medium that stores software for a dynamic localization service; and
at least one processor, coupled to the at least one non-transitory machine-readable storage medium, to execute the software that implements the dynamic localization service and that is configurable to:
receive queries from at least one database server into an ingestion pipeline, wherein keywords are extracted from the queries at multiple intervals;
apply tokenization in the ingestion pipeline to remove uninformative terms when attempting to extract keywords from the queries;
detect at least one query from the received set of queries that are resource intensive at a fleet level, individual server level, or user level based on the keywords and using an enrichment analysis module, wherein the at least one query detected to be resource intensive is given a drill-down analysis to capture insights from execution profiles, wherein the enrichment analysis module performs a historical statistical analysis to detect, flag, and categorize each query and identifies which queries with a computer processing unit (cpu) footprint and execution time that have breached a configuration threshold and a drill down analysis to identify a cpu projection trend and average cpu time per execution; and
provide alerts based on the at least one query detected to be resource intensive.

18. The computing device of claim 17, wherein a collector within the ingestion pipeline will apply tokens to retrieve keywords from the at least one resource intensive query.

19. The computing device of claim 17, wherein the alerts on the least one query are provided to at least one relevant stakeholder.

20. The computing device of claim 17, wherein the at least one query determined to be resource intensive is categorized by using a historical analysis task.
